(19) United States
(12) Patent Application Publication
(10) Pub. No.: US 2008/0172380 A1
(43) Pub. Date: Jul. 17, 2008

(54) Information retrieval based on information location in the information space.

(76) Inventors: Wojciech Czyz, Madrid (ES); Miguel Morales Angel Rubio, Alcala de Henares (ES); Elmer Ivan Wong Samaniego, Madrid (ES)

Correspondence Address: Wojciech Czyz, Princesa 27, 20.14D, Madrid, 28008, omitted

(21) Appl. No.: 12/015,481

(22) Filed: Jan. 16, 2008

Related U.S. Application Data
(60) Provisional application No. 60/885,356, filed on Jan. 17, 2007.

(51) Int. Cl. G06F 17/30

(52) U.S. Cl. 707/5; 707/E17.059

(57) ABSTRACT

A method and apparatus that enables specification of what search documents have to contain, where specification can have almost unlimited precision. The method allows specification directly using the proposed information location in information space or using other formats such as list of keywords or natural text, while method will translate it to information location in information space allowing user to easily check system understanding of his search specification and correct it.

When matching documents are displayed, their information location is displayed and user might correct it according to his knowledge, allowing system to influence information about documents basing it on information from several users.

### CROSS-REFERENCE TO RELATED APPLICATIONS

This document claims the benefits of the copending nonprovisional prior application with No. 60/885,356 and international filing date: Jan. 17, 2007, entitled INFORMATION RETRIEVAL BASED ON INFORMATION LOCATION IN THE INFORMATION SPACE.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The invention pertains to the field of classifying and searching information and relates to information retrieval systems. The subject matter of the claimed invention is classifying and searching information, some of the applicable U.S. patents Classification Definitions are:

707/1; 707/3; 707/4; 707/5; 707/7; 707/10; 707/100; 707/101; 707/102; 707/103; 707/104

Invented information location based on information retrieval has application in information systems that store information themselves or have access to sources of information. A system that provides information retrieval functionality is called a search engine. Information retrieval is also called information searching.

Invented method allows information retrieval by applying invented method of communicating with a system user, method of information searching and method of information organization. Invented system allows information retrieval based on information location in the information space.

### EXAMPLES OF INVENTION USES

The invention has application in any computing system, where information retrieval is forming part of its functionality. The following are some areas of applications: information technology, consumer electronics, media, law, medicine, commerce, etc.

### Examples of Applications:

Internet search portals, where invention allows searching for any available information on the Internet.
Search systems, which combine searching using known methods of information retrieval and the information retrieval based on information location in the information space.
Corporate portals or servers, where the invention allows retrieval of information in the corporate servers.
Software applications, where the invention allows retrieval of information managed or accessed by the application. Some of examples are e-mail application, database software, operating system, media management system.
Convergence devices, where the invention allows retrieval of information managed or accessed by the device. Some of the examples are: searching for contacts on mobile phones, searching for music or other media types on media players, searching for information on the mobile phone provider portals using mobile phone, searching for television channel transmitted in real time on the digital television system.

### EXAMPLE OF INVENTION USES (EMBODIMENTS)

Internet Search: on the FIG. 10, known text based searching is shown. Only search specification based on a textual description is available. On the FIG. 11, improved searching possible by incorporating new searching functionality using search specification based on information location is shown.

Media Player: on the FIG. 12, known text based searching is shown. Only search specification based on a textual description is available. On the FIG. 13, improved searching possible by incorporating new searching functionality using search specification based on information location is shown.

CRM/ERP application: On the FIG. 14, known text based searching is shown. Only search specification based on a textual description is available. On the FIG. 15, improved searching possible by incorporating new searching functionality using search specification based on information location is shown.

### DESCRIPTION OF RELATED ART

In patent U.S. Pat. No. 6,434,556 Visualization of search information some of the search parameters are entered using sliders similar to search bars presented in this invention, but they are not creating search specification nor are transformable to one as performed in this invention. Moreover, information about documents and relations between documents are strictly based on links and link keywords, not taking into account concept of the information location being crucial in this invention.

In U.S. Pat. No. 6,260,041 Apparatus and method of implementing fast internet real time search technology multiple document storing systems are checked for documents matching query, which is composed of list of keywords. There is no possibility to precisely identify which exactly information documents have to contain, as there is no way to specify information location in information location of desired documents. Keyword based information about documents is lacking precision offered by specifications based on information location in information space.

In U.S. Pat. No. 6,321,228 Internet search system for retrieving selected results from a previous search an attempt was made to improve searching experience of the user by treating searching as iterative process. However, user have no way to know how exactly his search specification (query) was understood by system nor correct this understanding or his search query to mean really what he wanted. In this invention, by translating search specification to information location in information space user sees exactly how his query will be understood and which documents he will receive (also by directly expressing search query as information location).

In U.S. Pat. No. 7,228,492 B1 2D Graph displaying document locations of user-specified concept of interest, description is given of the system detecting concepts and their occurrence in document or it's fragment. Concepts are specified as keywords, number of their occurrences is counted. The solution crafted according to that patent lacks possibility of exact specification of concepts, using relations between concepts to better detect concept occurrences and especially, lacks definition of information as a area in information space, build from information dimensions which in turn are built using concepts.

In U.S. Pat. No. 6,484,164 Data search user interface using ergonomic mechanism for user profile definition both search specification and search results are shown as graphical objects, however there is no universal way of saying all information about found documents or search specification just by looking at the display. In this invention, information location is considered to be universal way of showing information about documents.

In U.S. Pat. No. 5,832,474 Document search and retrieval system with partial match searching of user-drawn annotations, direct graphical objects are used to compare information about documents. Graphical information about documents is not processed in any way except of immediate graphic comparison test, which limits uses to very limited set of data.

The following patents are related to the invention:
U.S. Pat. No. 4,823,306; Title: Text search system
U.S. Pat. No. 6,269,361; Title: system and method for influencing a position on a search result list generated by a computer network search engine.
U.S. Pat. No. 6,006,225; Title: refining search queries by the suggestion of correlated terms from prior searches.
U.S. Pat. No. 6,377,945; Title: search system and method for retrieval of data, and the use thereof in a search engine.
U.S. Pat. No. 5,297,249; Title: Hypermedia link marker abstract and search services.
U.S. Pat. No. 5,920,854; Title: Real-time document collection search engine with phrase indexing.
   Other patents that are lacking significant steps and solutions of this invention include:
U.S. Pat. No. 6,321,228; Title: Internet search system for retrieving selected results from a previous search.
U.S. Pat. No. 7,003,730; Title: Graphical user interface to build event-based dynamic searches or queries using event profiles.
U.S. Pat. No. 6,681,370; Title: B2 HTML/XML tree synchronization.
U.S. Pat. No. 6,041,323; Title: Information search method, information search device, and storage medium for storing information search program.
U.S. Pat. No. 6,701,314; Title: System and method for cataloguing digital information for searching and retrieval.
U.S. Pat. No. 6,397,211; Title: System and method for identifying useless documents.
U.S. Pat. No. 6,377,961; Title: Method for displaying internet search results.
U.S. Pat. No. 6,278,993; Title: Method and apparatus for extending an on-line internet search beyond pre-referenced sources and returning data over a data-packet-network (DPN) using private search engines as proxy-engines.

Most popular publicly known searching engines are Internet portals of Google, Yahoo and MSN. Existing searching engines search information specified using search specification based on a textual description. User provides search specification based on a textual description, to the search engine, which is interpreted. After the search specification is entered, the engine looks for the pages related to the search specification and shows search result. Search result usually contains a list of one or more descriptions of matching information and links to full information.

Search engine user can select any of the entries of the search result to navigate to the related page. If the system user is not satisfied with the result, he can enter different search specification and restart the searching process. The actual known searching solutions have several limitations. One of them is the vague searching precision. It is very difficult to search exact information using search specification based on a textual description because: user is often unable to express his exact intention as the search specification based on a textual description, search engine is unable to correctly interpret good search specification based on a textual description and search specification based on a textual description, usually generate too many matching information.

As the result, the search specification based on a textual description entered by the user can give undesired results like large amount of results or results which are not matching the intention of the user.

If the search results shown are undesirable (too many or not matching user intention) system user must modify the search specification based on a textual description and retry the process.

There is no way to gradually correct the results that search engine found to be closer to the real intention that the system user had. The system user has to try several search specification based on a textual description, but until he sees the correct result he does not know what is the “good” search specification based on a textual description to express his intention. He has no guarantee he will ever find the correct search specification based on a textual description and thus find the result within short time, because he has no way to gradually “move” the search engine towards the intention he had.

Invented method allows information retrieval by applying invented method of communicating with a user, method of information searching and method of information organization. Invented system allows information retrieval based on information location in the information space.

### BRIEF SUMMARY OF THE INVENTION

The present system and method relates to information retrieval and classifying systems. The system can be used by one or more users who can classify the information into information dimensions.

Information retrieval is performed using the search specification based on an information location in the information space alone or in parallel with search specification based on a textual description which is specified by a system's user. Information retrieval could be performed using more of other additional types of search specifications. Using information dimension based search specification as one of search specifications permits searching with better precision and finding results faster.

Search specification based on information location is built using information dimensions. Every information dimension is constructed by taking two concepts with different (ideally related concepts with completely opposite meanings). Concepts can be expressed by words, images or any other symbols. Information dimension defines a range within the information space, information location can be placed anywhere on this range.

Using search specification based on information location, the location of the desired document within the entire information space is determined. All documents that are within or close to desired information location are presented as a result of information retrieval. The information space is implementation of vector space, which are known and defined as mathematical concept of algebra.

### BRIEF DESCRIPTION OF THE DRAWINGS

These and other features, aspects and advantages of the present invention will be more fully understood when considered in connection with the following specification, appended claims, and accompanying drawings, wherein:

FIG. 1 is a representation of information location of search intention and information location of interpretation of search specification. On this figure, the difference between search intention and the interpretation of search specification is illustrated. The subspace of the information space is shown, which is built using two information dimensions, information dimension A and information dimension B. The subspace of the information space is represented on the figure as a two-dimensional space, where every location on the subspace is equivalent to some concept. Information location may be identified by giving coordinates of the information dimension A, and information dimension B. As presented, using known methods information location in information space is easily presented graphically as flat graphical representation of vector space.

Within the information space, two information locations are marked, one of them represents “search intention” and the second one represents the “search specification interpretation”, which is the engine's search specification interpretation. “Search intention” has coordinates A1 and B2; “search specification interpretation” has coordinates A2 and B1. Both locations differ, so to find exactly the same information that corresponds to the true search intention, information location of “search specification interpretation” should be corrected to be the same as information location of the “search intention”. Information location of search specification interpretation can be presented as search specification based on information location and as such can be easily corrected.

FIG. 2 is a representative schematic block diagram illustrating a basic general structure of the invented system for multiple users.

FIG. 3 is a representative schematic block diagram illustrating the general structure of the invented system.

FIG. 4 is a representative schematic block diagram illustrating a detailed structure of the invented system. In the figure, the following conventions are used:
Subsystems are marked using rectangles with dashed line and names with italics characters.
Data and control flows are illustrated with arrows. Bigger arrows represent the most important flows.
Data stores are illustrated with cylinders. They can be database, file or any other way of storing plurality of information.
Data objects, passed between data processing modules are shown as ovals.
Data processing modules are shown as rectangles.

FIG. 5 is a representation of the user interface of the invented system.

FIG. 6 is a representation of information location defined by using two information dimensions.

### Description of the Figure:

Information location is marked on the information subspace defined by two orthogonal information dimensions: information dimension A and information dimension B. Information location is representing some information, information itself is not shown on the figure. Information location is marked on information dimension A as range, ranging from coordinate A1 till coordinate A3. Information location is marked on information dimension B as range, ranging from coordinate B1 till coordinate B3. The centre point of the information location can be expressed as coordinates A2 and B2. Centre point can be calculated using mediums of the ranges of information locations on every information dimension. As presented, using known methods information location in information space is easily presented graphically as flat graphical representation of vector space.

Table 1 shows values of Information location on single information domain.

TABLE 1
Values of Information location on single information domain.

| | information | relation | relation |
|---|---|---|---|
| | location | with | with |
| Situation | value | concept A | concept B |
| Concept equal with concept A, | −infinite | +infinite | 0 |
| being its synonym. Concept | | | |
| opposite with concept B, | | | |
| being its antonym. | | | |
| Concept being equally | 0 | +infinite/2 | +infinite/2 |
| related to concept A | | | |
| and concept B. | | | |
| Concept equal with concept B, | +infinite | 0 | +infinite |
| being its synonym. Concept | | | |
| opposite with concept A, | | | |
| being its antonym. | | | |

FIG. 7 is a representation of information location defined by using three information dimensions. As presented, using known methods information location in information space is easily presented graphically as pseudo three dimensional graphical representation of vector space.

FIG. 8 is a representation of a graphical element of user interface controlling location on single information dimension. Description of the figure:
The image represents example of one search bar implementation. Search bar is displayed on the user interface of the system. The bar represents one information dimension; two different concepts that are located on the extreme sides of the search bar. When system user moves sliding knob, he changes information on this information dimension. When moved towards one of the expressions expresses to the system that the searched information is more related to that expression. Using mouse or keyboard, user can also change the size of the sliding knob. Initially representing single location on the slider, extending the knob allows selecting a wider range. Using mouse or the keyboard, more knobs could be added to the search bar, to allow indication of several ranges.

FIG. 9 is a representation of graphical elements of user interface controlling information locations. To represent information location in information space, several information dimensions must be used. On this figure, graphical elements of user interface controlling information location are shown. Description of the figure:
The figure represents set of three search bars, each of them representing value on single dimension. The sliding knobs on all three are in the middle of the search bar, representing neutral location. Each of the individual search bars has behavior as described above, in description of example implementation of singe search bar. The more information dimensions are used, the more search bars are needed on the display and the more precise the information location represented by bars.

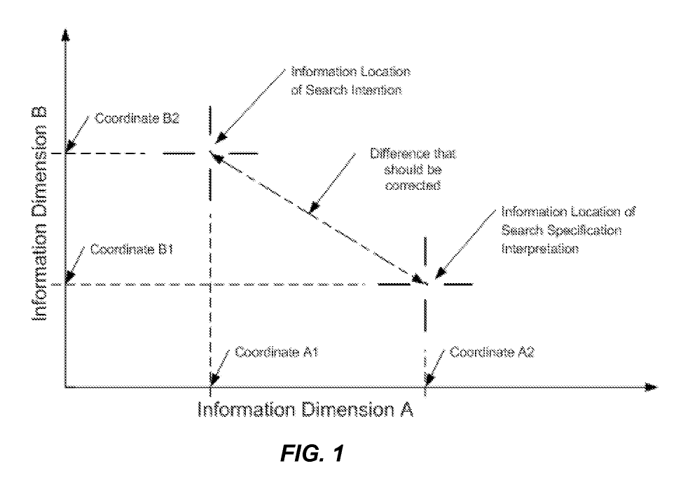

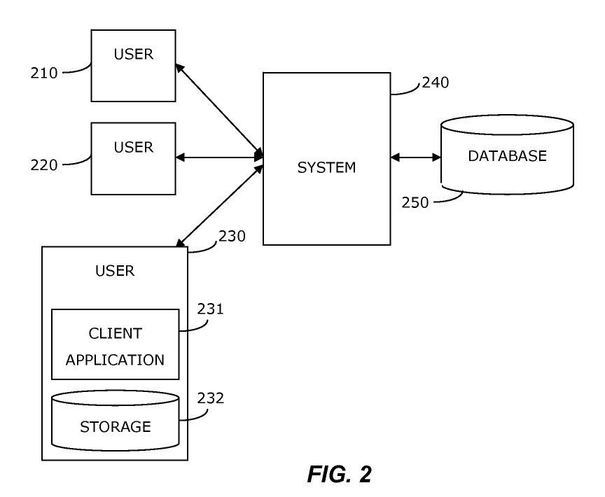

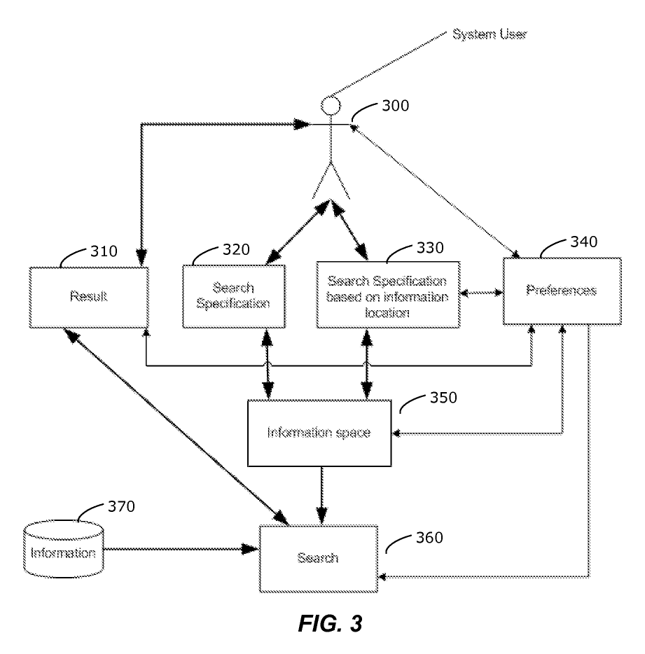

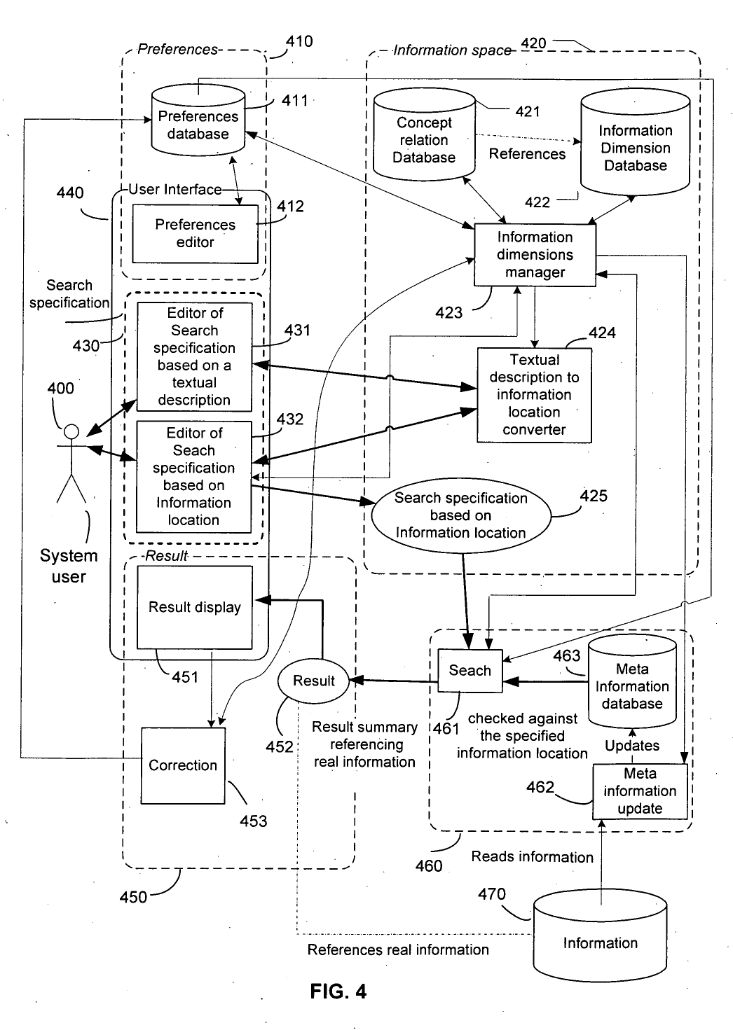

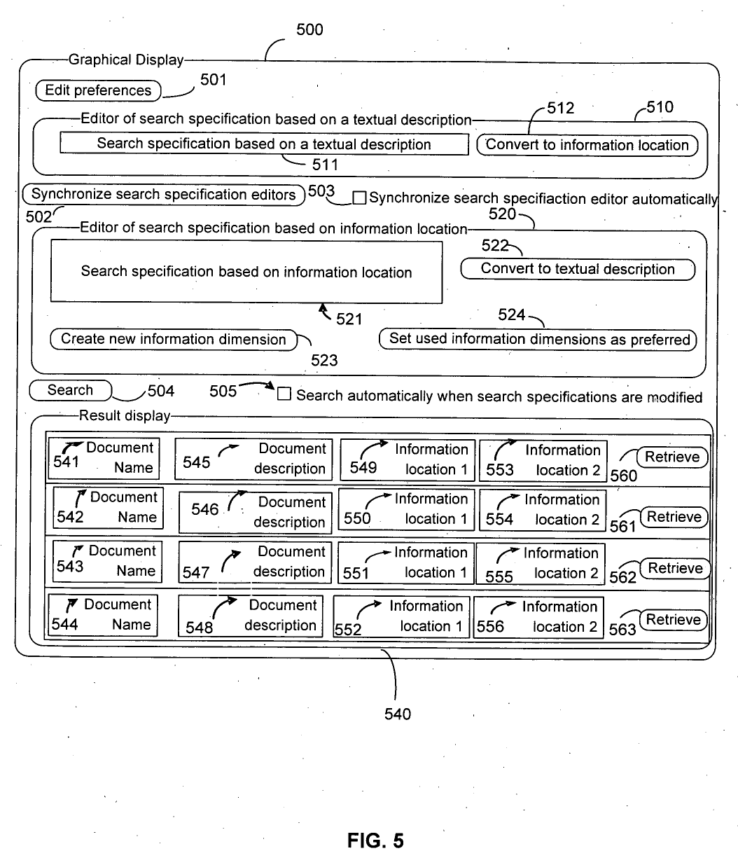

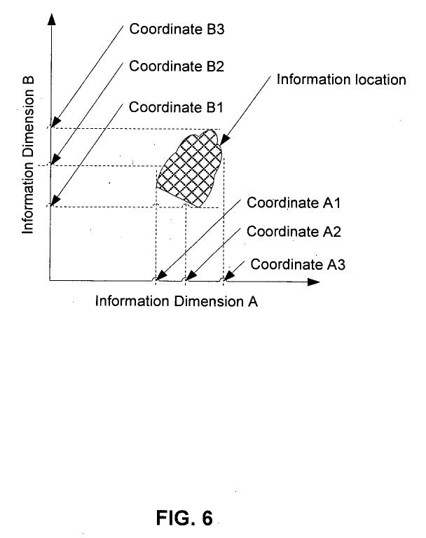

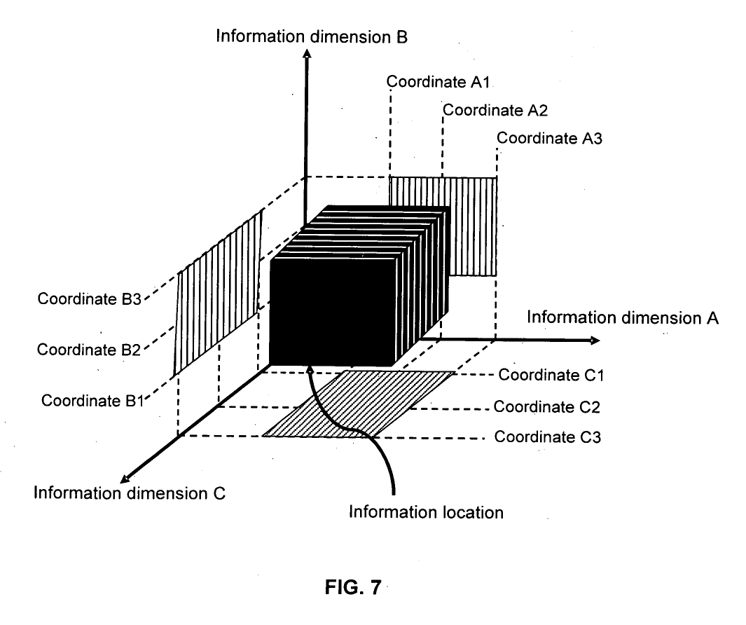

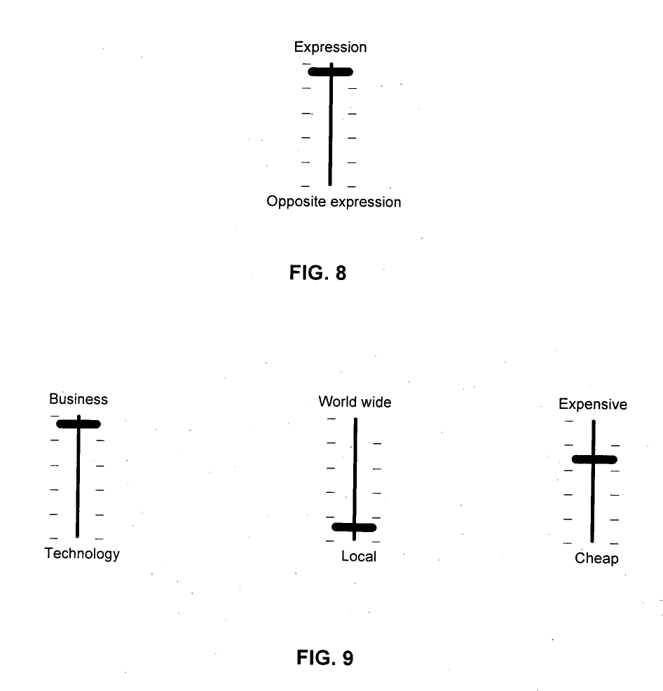

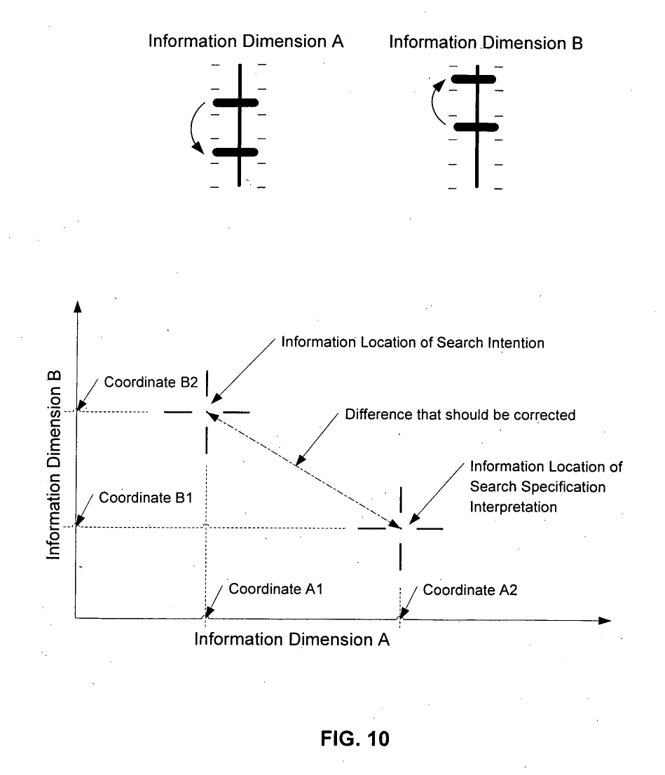

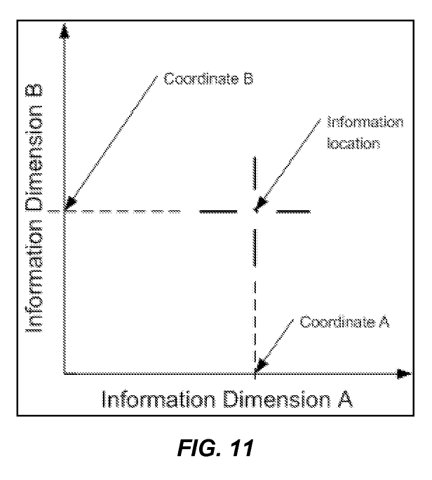

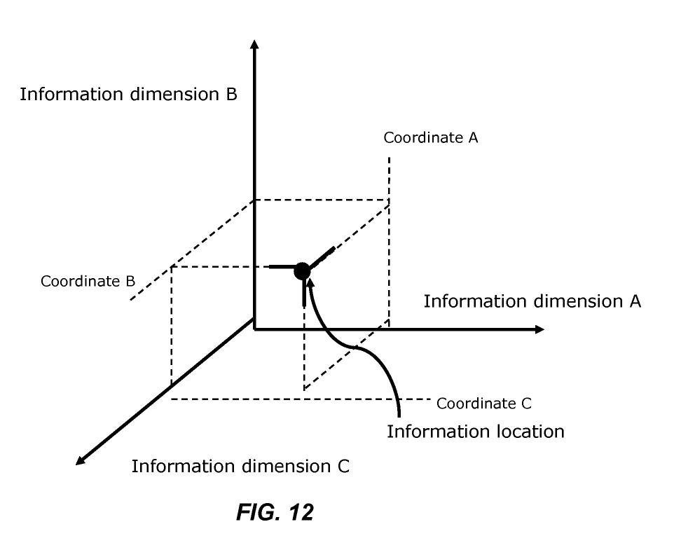

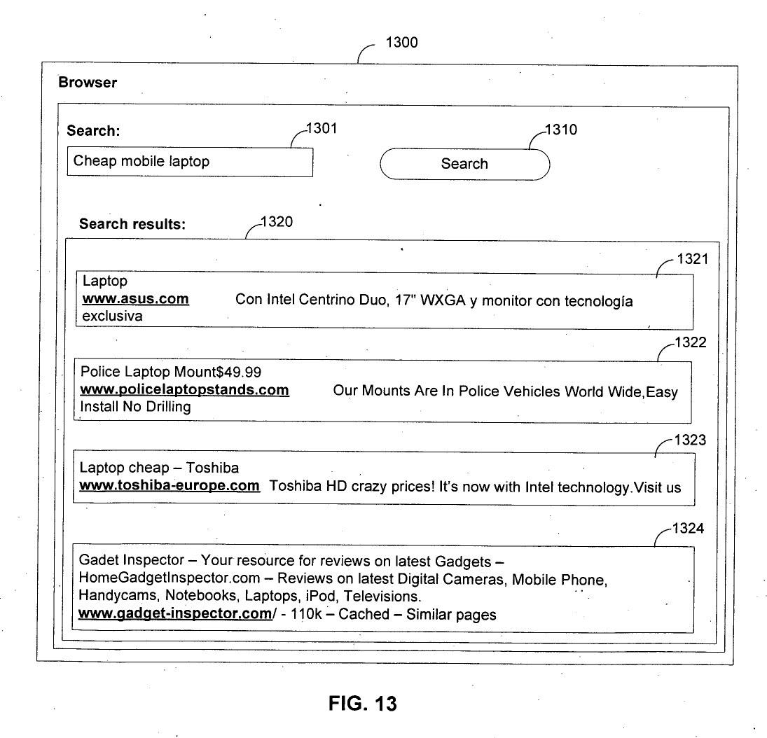

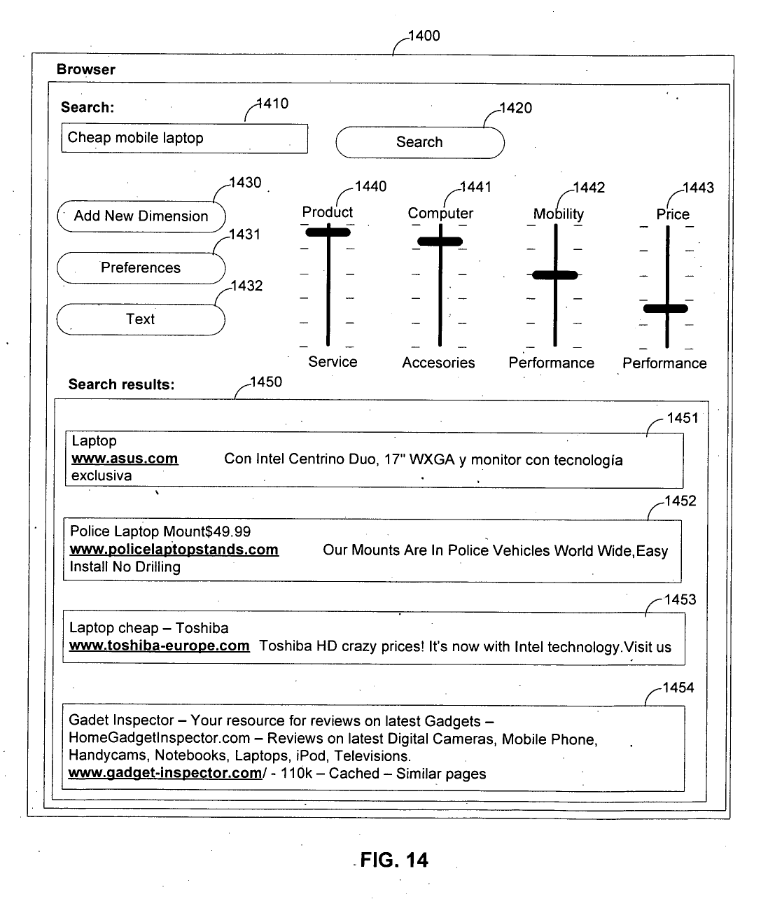

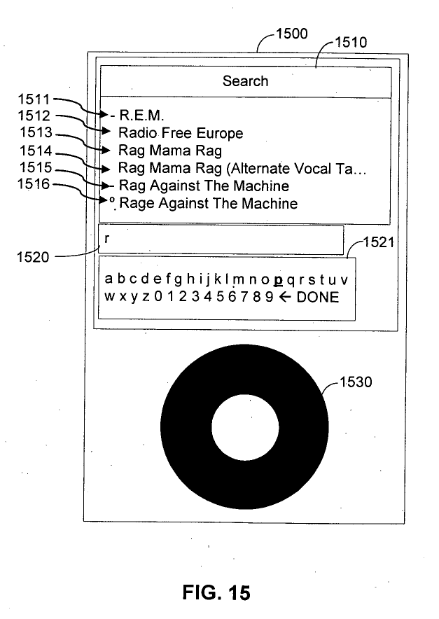

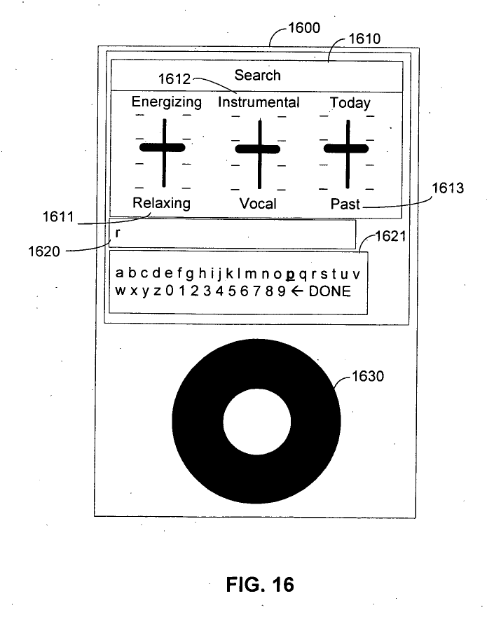

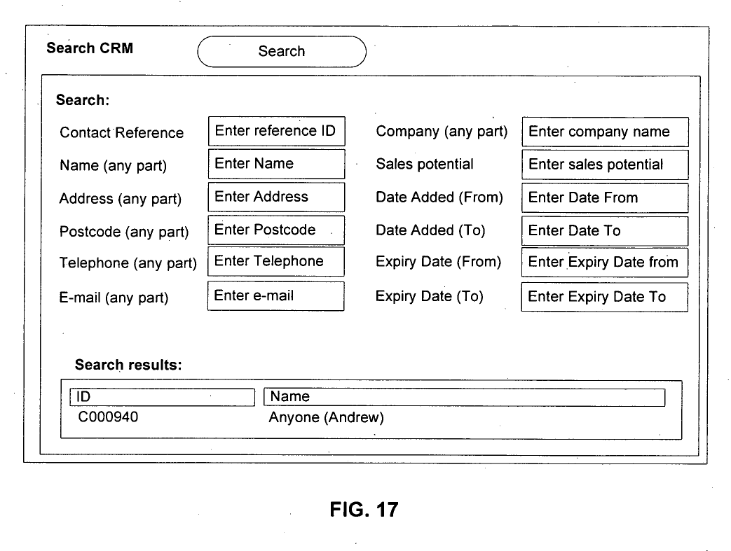

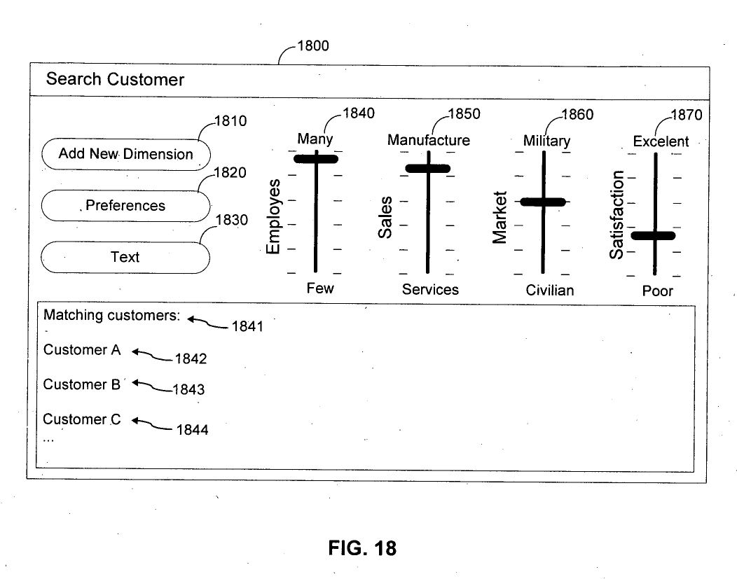

FIG. 10 is a representation of the relation between the information location and the bars used to specify the information location.
This figure is extension of FIG. 1, Information location of search intention and information location of interpretation of search specification. Modification of information location using the bars is shown. Arrows accompanying the bars representing information dimensions A and B show the modification. Corresponding modification of information location is shown on the model.

FIG. 11 is a representation of information location within a two dimensional information space.

### Description of the Figure:

The subspace of the information space is shown, which is built using two information dimensions, information dimension A and information dimension B. The subspace of the information space is represented on the figure as a two-dimensional space, where every location on the subspace is equivalent to some concept. Information location may be identified by giving coordinates of the information dimension A and information dimension B.
Within the information space, an information location is marked as cross with the single point in the middle. It corresponds to the coordinates on the information dimensions, marked by the thin lines crossing with the information dimension axis, where Coordinate A describes information location using information dimension A, and Coordinate B describes information location using information dimension B.

Information dimension axis are shown as perfectly orthogonal, this is expressing that information dimensions are also orthogonal.

FIG. 12 is a representation of information location within a three dimensional information space.

FIG. 13 is an example of the known engine user interface.

FIG. 14 is a representation of the known search engine improved by including invented system.

FIG. 15 is an example of known media player search engine user interface.

FIG. 16 is a representation of known media player search engine improved by including invented system.

FIG. 17 is an example of known CRM/ERP search engine user interface.

FIG. 18 is a representation of CRM/ERP search engine improved by including invented system.

### DETAILED DESCRIPTION OF THE INVENTION

Invented method allows information retrieval by applying invented method of communicating with a system user, method of information searching and method of information organization. Invented system allows information retrieval based on information location in the information space.

There are several common terms used in many places in this document, they are described in the following paragraphs, being followed with the detailed description of the invented method and the apparatus.

### DEFINITION OF TERMS

### Definition: Information Dimension

All information has its location within set of information dimensions that are defined in the information space. Information dimensions can be used in any context of describing information by specifying its information location within information dimensions. In invented method and system, information dimensions are used to describe the search specification based on information location and information that system has access to.

Information dimension is the concept similar to the mathematical dimensions. They correspond to vectors that build up vector spaces being one of the concepts of algebra. In mathematics, every point has its unique location within set of dimensions. It can be located using its coordinates. In one dimensional system there is one coordinate, in two dimensional two, three dimensional 3 coordinates, etc. Information dimension corresponds to mathematical concept, being defined in the information space. All information can be placed within the multidimensional information space, where information location can be decomposed to set of coordinates described on information dimensions. To simplify the description, those coordinates on information dimensions will be described as locations on the dimension. Location on information dimension is determined by relation of the information to concepts expressed by information dimension. (Please refer to definition of INFORMATION LOCATION for more information).

Information dimensions used by the modules of the system are predefined in information dimension database, and can be constructed by dimensions manager using concept relations database. Example of the dimensions:

Science—Art;

Detailed—General;

Expensive—Cheap;

Belief—Fact;

Cold—Hot;

Material—Abstract.

Information dimensions can be named, where preferred names are coming from the names of concepts that information dimensions are build of. Because concepts can be expressed in one or more languages, also information dimensions can be expressed in one or more languages.

### Definition: Concept

One or more words, that express concept. Concept can be expressed as a single information location in the information space. Concept can have one or more information related to it. When system user is looking for some concept, system will find all related documents that system has access to.

Examples: Amsterdam, cheap portable laptop, hot crowded vacation destination.

Concept is independent from human language, only its representation is done using set of human languages. System will have concept representation using one or more human languages.

Definition: Orthogonal (independent)

The orthogonality of two information dimensions is the independence of them. If they are orthogonal, the information dimensions are independent. The location of a concept on one of information dimension will not influence the location of concept on the other information dimension.

Examples of orthogonal information dimensions: north-south, east-west, expensive-cheap, popular-unknown.

Orthogonality can be expressed by numbers, for example: infinite representing totally orthogonal information dimensions, and zero representing totally non-orthogonal (parallel) information dimensions. Orthogonality of dimensions will be stored by the information dimension database, and used by the “description to location converter” and “search” modules to make sure that searched information and results are described by set of as few as possible information dimensions which are with each other as much orthogonal as possible.

Please note, that “orthogonal” is different concept than “opposite”. The opposition and orthogonality have feature, which is used in the information dimension database and in the search blocks. If there is information dimension that contains WordA and WordB (Word A is opposite to WordB to some degree) and WordC is orthogonal to WordA, WordB is also orthogonal to WordC.

In algebra, orthogonal is also called perpendicular.

### Definition: Search Specification

The way user expresses/describes to the search engine the document he is looking for. In the invention, search specification is search specification based on information location used in parallel with the standard search specification based on a textual description. Using search specification based on information location permits searching with better precision and finding results faster than only by search specification based on a textual description.

### Definition: Search Specification Based on a Textual Description

Textual specification, as used in most existing search systems. It is usually combination of: exact searched phrase, keywords related to the searched information, logical operators (such as AND, OR, NOT, +), natural text description of the searched item.

### Definition: Search Specification Based on Information Location

Search specification based on information location is information location of the desired information. Please refer to INFORMATION LOCATION for more information. In general, search specification based on information location is a set of information dimensions with information location marked. Information locations marked on all information dimensions specify where the user is expecting to find searched information.

Search specification based on information location can specify within information space:
Single point: This variant can be used to describe document that contains only very specific information.
Centre of information location, with optionally given maximum range. This variant can be used to specify the documents that contain more general information.
Information location with specific ranges marked. This variant can be used to specify the documents that contain more general information.

If information location of document is partly outside of the Search specification based on information location, it can be treated as too general, or as SPAM that should be excluded from search result. One of two scenarios can happen:
Document is still accepted as result, possibly presented separately from documents, whose information location fit entirely within search specification based on information location.
Document is excluded from search result.

This setting can be part of preferences and of search specification based on information location.

### Definition: Information Location

Is a way of locating and classification of information within one information dimension or set of information dimensions. It also can be described as information placement or information coordinates within set of information dimensions.

Location described with single information dimension could be expressed as single number, which could be:
Saturation of concept that could range from none to full expressed for example by number ranging from 0 to Infinite. This is useful for the concepts which do not have antonyms. If coordinate of the Information is valued 0 for this information dimension, the information has no relation with the concept expressed by the information dimension. If the coordination is valued Infinite, the information has strongest possible relation with the given concept.
Placement between two different (ideally opposite, for example antonyms) possibilities of concept, expressed for example by number ranging from “−Infinite” (concept A) to “Infinite” (concept B, being opposite of concept A).
   Location on set of information dimensions could be expressed as set of numbers, where every of them is location on corresponding dimension. Also, single numbers could be extended to express more complex locations within dimensions such as range, set of ranges etc.

Information location can be either point or ranges on a set of information dimensions. In case it is expressing single coordinate for every information dimensions, it is important to note if it really expresses single point in information space or centre of information location. In case centre of information location is expressed, radius of the information location must be specified.

FIG. 6 is a representation of an example of information location defined using two information dimensions, and FIG. 7 is a representation of an example of information location using three information dimensions.

Documents, whose information location is defined as single point, contain very specific information. On the contrary, documents whose information location is specified as set of ranges are more general and contain more pieces of information. If ranges of information location are very wide, document is either very complex or could be SPAMMING, an artificial document that is containing many, often unordered information that as a collection have very low value.

### Definition: Representing Information Location

Information location can be expressed and controlled in several ways:
Alphanumerical—Set of locations on one or more information dimensions, where for every information dimension the following would be displayed: information dimension name, the minimum and maximum ranges of locations on this information dimension, list of the ranges within the information dimension that describes information location.
User can read this description on display device and modify using keyboard or other input devices.
Graphical display composed of set of bars and additional information. Every bar represents one information dimension, having its name displayed (which could be composed using the opposite words creating the dimension), and information location marked with points or lines, preferably using various colors. User can see marks on bars on display device and modify them using mouse, keyboard or other input devices. Some of the variations of graphical display could be:
   Set of lines representing information dimension, with accompanying text and numbers. The selected information location is marked on the line with different color (or style, line thickness etc).
   Slider controls as used in typical applications, for example those controlling audio volume on Windows Operating systems. Their functionality could be extended to mark a set of location or set of ranges, instead of only one location.
   Flat, pseudo 3D or full 3D representation of selected information dimensions, where searched information location could be represented as flat or 3D objects.
Other way of representing the same concept.

### Examples of Representations:

The following are examples of representations of the information location on the graphical user interface. System would display the information location and allow user to modify it using typical devices such as keyboard, mouse or voice.

To represent information location on single information dimension, the graphical item could be displayed on the user interface. On the FIG. 8, graphical element of user interface controlling location on single information dimension is shown.

To represent information location in information space, several information dimensions must be used. On the FIG. 9, graphical elements of user interface controlling information location are shown. On the FIG. 10, relation between the information location and the bars used to specify the information location is shown.

### Definition: Search Engine

Apparatus, that allows searching of the documents or meta-information by mean of information computing system. Here are some of possible implementations:
Software program executed on one or more computer system,
Search engine functionality accessed remotely from other computer based system,
Software and hardware combinations to improve performance, lower power consumption, etc.

### Definition: Information Location Based Search Engine

Information location based search engine is using search specification based on information location to specify desired information. This specification can be used alone or combined with other search specifications, such as search specification based on a textual description. Once information location in the information space of both search specification and document information is known, searching is simply matching those of them which have distance of central points smaller then predefined. Distance equal to 0 will express full match of document and search specification. More exact comparison is performed by calculating percentage of intersecting area of both information locations, intersection of 100% corresponds to full match of document and search specification. Example implementation of the information location based search engine is described in SYSTEM.

### Definition: Information

Information is related to one or more concepts, and has its information location in the information space. Information location of single information is a point in the information space. Information is data that user could be looking for. Information can be searched according to its classification, done according to information location, content, name or other characteristics.

### Definition: Document

Document contains information. Document can contain precise information such as “description of architecture of computer type IBM PC XT”. It can also contain set of general information that make the document more general one. Web page of United Nations treated as document would be a collection of much information. Every document has its information location determined by all the information it has. Information location content may be specified manually (by the document author or by organizations classifying documents) or automatically (by “Search” subsystem of the invented system or by external systems).

Automated specification of the document information can be performed using following functions:
Average of information locations of all information forming document, resulting in specification of single point in the information space. Additionally, the radius can be specified as the distance from the average to the most varying information forming document.
Sum of information locations of all information forming document, resulting in information location specifying ranges on set of information dimensions.
Combination of above function, allowing specifying the single information location using less information dimensions than used when specifying all information forming documents.

In this invention application, word “document” will be also used as name for single document from all documents that can be searched upon. It includes desired document, document that will be found using search method or system. Document could have a form of: text, image, sounds, music, complex such as web pages, Office documents, etc.

Document could be stored on computing systems as: files, records in file, database, database table or database table field, other method allowing reading information, looking it up according to its name and/or content and/or associated keywords.

### Definition: Search Bar

Search bar is a way of expressing the information location on a single information dimension. Set of search bars, can be used to express an information location and search specification based on information location. Please refer to Representing information location for example implementations of search bars.

### Definition: Information Space

All the information that exists can be located in the information space. It is limitless. Information location within the information space can be described by a set of information dimensions. Subspaces can be defined, using limited set of information dimensions. Information space and all operation in information space correspond to operations in vector space in algebra. Transformations are moving combined with scaling of objects, comparing is measurement of area and distance of objects.

To mark information in the information space, information location is built using set of information dimensions. Used information locations will define subspace of the information space. The more information dimensions are used, the more accurate information location is. On the FIG. 11, information location within the information space is shown.

Variations: the information space could have varying gradations of a concept alongside the specific information dimension. It could be linear, non linear (parabolic, etc). The information space gradation could be set by user in order to improve information differentiation in some locations of the information space and degrade it in other ones, that user are not interested in.

### Definition: Information Retrieval (Also Called Information Search)

Process of searching for desired information. Desired information is specified by search specification of some form.

### Definition: Personalization of Search Sensitiveness

System has predefined information dimensions stored in the information dimension database. Additionally, they can be personalized by the user changing the way that system builds the information space. User can modify linearity of subspaces in some areas of the information space by modifying the relations between words that build dimensions. This is described in the information dimensions and information dimensions database.

The system identifies a document (single piece of information that can be searched) in the information space. The information location of every document is described as a set of ranges in one or more information dimensions. The system may generate a score for the document based, at least in part, on information location. The system allows rapid and accurate specification of the desired retrieved information by a user of the system. The system allows visualizing and correcting the system's interpretation of the request given by a user.

### Method

The invented information retrieval method is based on the concept of “information location” within the information space. Document can be retrieved, once its location is specified. In other words, information location can be used to specify which documents should be retrieved.

The search intention is the perfect result of information retrieval. Search intention can be located as a specific point or range within the information space. It can also be called search specification based on information location. The invented method uses set of parameters when operating. Those are called “method parameters” and include: relations between concepts, information dimensions used in Phase 2 and Phase 3 and concepts preferred in the automated process of creation information dimensions.

Values of “Method parameters” that are always applied before method is used are called “Predetermined values of method parameters”. “Method parameters” can later be modified during execution of method and if needed, their values can be stored:
Temporary, for the execution time of the method,
Permanently for the current context, being restored to stored value always when method is executed in a given context,
Permanently, modifying “Predetermined values of method parameters”.
   Context of method execution is determined by:
Sequence of method uses, performed to reach some goal.
User using the method,
Group of users, that the method user belongs to.
   The invented method is composed of the following phases:
Phase 1: preparation of method parameters.
Phase 2 (optional phase): acquisition of auxiliary search specifications. This optional phase is used to predefine entry search specification based on the information location, which is later on modified in phase 3.
Phase 3: acquisition of a search specification based on the information location.
Phase 4: retrieval of documents matching search specification based on the information location.
Phase 5: presenting the result.
Phase 6 (optional phase): correction of the method parameters, based on rating and corrections of the presented results.
   The invented method consists of the following detailed steps:
Phase 1: Preparation of method parameters
   Step 1: “Method parameters” are set to “predetermined values of method parameters”. They could have been modified in previous usages of the method.
   Step 2 (Optional step): Context of method usage is detected, by determining method user, group the user is belonging to etc. “Method parameters” are overwritten with “predetermined values of method parameters used in specific context”, that could have been modified in one of the previous usages of the method.
   Step 3 (optional step): “Method parameters” used for the current use of method are modified by the method user. If requested by the method user, modified “method parameters” are stored as “predetermined values of method parameters used in specific context”.
Phase 2: Acquisition of auxiliary search specifications. This optional phase is used to predefine an entry search specification based on the information location, modified later on in the phase 3.
   Step 4: Search specification is specified in a format corresponding to the search specification type.
   Step 5. Search specification is translated to the search specification based on the information location. For the search specification based on a textual description following operations are performed:
      Using known methods, textual description is converted to the set of one or more “basic concepts”.
      A set of information locations is produced, where each information location corresponds to one “basic concept”. For every “basic concept” the information location of the “basic concept” is determined on predetermined information domains.
      Set of information locations of “basic concepts” is processed to form single information location. Simplest processing might be sum of information locations, average of the information locations, a combination of both, etc. This process is done according to operations in vector space, defined in algebra.
Phase 3: acquisition of the search specification based on the information location.
   Step 6: Initial information location of the search specification based on the information location is set. This will be one of:
      Neutral initial search specification. This can be predefined set of dimensions with predefined or neutral information locations set on them.
      Search specification based on information location generated in Phase 2.
   Step 7. Search specification based on the information location is modified to reflect the intention of use of this method. Possible modifications include:
      Adding predefined information dimension,
      Adding information dimension, newly defined by using two concepts from the predefined set of concepts,
      Modifying information location on used information dimensions.
Phase 4: Retrieval of documents matching search specification based on the information location. The following two steps, steps 6 and 7 are repeated, for every document. The operation could be interrupted by conditions such as enough result documents are collected or operation has exceeded the allowed time.
   Step 8. Information dimensions that are used in search specification based on information location are transformed into information dimensions that are used in specification of the information location of the document. This transformation can be done by comparing the relations between concepts that build the information dimensions of information location of document and search specification, location on the information will be modified to reflect its location relative to the new concept. Transformation corresponds to transformation of points and line fragments in vector space, being scaled and moved, also called rotating. All those operations are commonly known and defined in algebra
   Step 9. Information location of the desired information transformed in the previous step and information location of the document are compared to each other. If the distance of central points of the information location is smaller than the one agreed to be acceptable, the document is added to the results. Better variant of comparison is calculating intersecting area of both information locations, considering full match as 100% of area being and intersection and no match at all as 0% of area being and intersection. Both types of comparisons are done according to known methods in vector space in algebra.
Phase 5: Presenting the result.
   Step 10. Search results are presented. For every document found, its basic information is presented like so summary, name, exact information location, using original or translated information dimensions, or both information locations.
Phase 6. Optional phase: Correction of the method parameters, based on rating and corrections of the presented results.
   Step 11. Information location of one of the documents shown in the result is modified.
   Step 12. Method user is given a choice of a correction:
      Correction of the information location of a single document in the information space, if selected, the following step is executed:
      Step 12.a: for each information dimension of the information location that was modified, the information location of the document on that information dimension is memorized and applied in the future uses of the method in the same context. The context may be determined by the user, group the user is belonging to etc. Group may be defined explicitly such as community or implicitly such as determined by language used geographical location etc.
      Correction of the concept relations building the information space, if selected, the following step is executed:
      Step 12.b: for each information dimension of the information location that was modified, the corresponding relation between concepts in the concept relation database is identified and modified. The modification is memorized, and applied in the future uses of the method in the same context. The context may be determined by the user, group the user is belonging to etc.
   Step 13: The correction is examined, to check if it may apply to the wider group of method users. Examination may be determined using known methods, such as statistical processing of correction done by different users, investigation of locations of modifying users, etc. If the correction is accepted to be applied for wider group of method users, corrections are applied directly to the single information location of the document or “Predetermined values of method parameters”, according to the selection made in step 12.

When the method is executed, at any time search specification based on information location can be modified. Should this happen, method is interrupted and its execution is restarted from Phase 3.

The invented method allows using search specification based on a textual description and presenting its interpretation by the method. The interpretation of the search specification will be presented as search specification based on information location. Original search specification or its interpretation presented as search specification based on information location can be modified before the search operation starting with Phase 4 is started. See FIG. 1.

### Variations

Phase 4 can be modified by using known method of information retrieval, which would be used with input parameter expressed either directly using search specification based on information location or translated to different type of search specification. In case search specification based on information location is used directly by the replacement information retrieval method, its interpretation can be different than proposed in search specification based on information location.

In case the replacement information retrieval method requires search specification based on a textual description, the following conversion steps are taken for both information dimension of information location search specification and for the description of documents, if documents are described using information location:
Every information dimension of search specification based on information location is decomposed to concepts it is build of. Result would be two concepts per information dimension, which are called “base concepts”: “base concept A” and “base concept B”. The following steps are repeated for every pair of “base concepts”:
All concepts related to each of the “base concepts” are retrieved from Concept relation database.
From all related concepts, those are selected, that have its relation with “base concept A” and “base concept B” proportional to the information location on the information dimension that is formed from those base concepts. Please refer to information location for indication of proportionality. The keywords representing concepts are used as textual description. This operation corresponds to known operation of dropping points onto the lines in vector space in algebra.
Optionally, resulting keywords are filtered out, to reject ones that do not match the group of concepts resulting from conversions of other dimensions. Known algorithms for detecting information that do not match the rest of information could be used, such as ones used for removing SPAM information.

Phase 4 can be modified, to use descriptions of documents different than information location. Documents can be described using textual description, Web Ontology Language and the Resource Description Framework defined by W3C, list of keywords, direct usage of document content, etc. Before search operation is performed, document description must be translated to information location in the information space. This is a very similar operation to the one performed in Phase 2. Using relations between concepts forming information dimensions of a search specification based on information location, and the description of the document, the information location of the document can be constructed. For a textual description based specification, the following conversion steps must be taken:
Using known methods, a textual description is reduced to the set of one or more “basic concepts”.
A set of information locations is produced, where each one corresponds to one “basic concept”. For every “basic concept” the information location of the “basic concept” is determined using all the information domains that are taken from a search specification based on information location.
Set of information locations of “basic concepts” is processed to form single information location. Simplest processing might be sum of locations, average of the locations etc. This operation corresponds to known operation of approximating points on the line in vector space in algebra.

Information about documents can be organized in such a way, that during Phase 4, information location of entire groups of documents could be compared to the search specification based on information location. Examples of such organizations could be an information tree, where subspaces of the information space would form leaves of an information tree.

### System (Also Called Apparatus)

The invented system of the information location based search engine is using the invented method of information location based searching and is one of the possible implementations of the invented method. Information search is done by search engine, which is implemented as computing system. Examples of such computing system are computer software or software and hardware combination.

The FIG. 3 is a representative schematic diagram illustrating the general structure of the invented system. Description of the figure:

“System User” (300) is entering either search specification based on information location into the “Search Specification based on information location” subsystem (330) or is entering other form of search specification using “Search Specification” subsystem (320). Both search specification subsystems are interconnected using “Information space” subsystem (350), to allow updating of the other subsystems search specification when search specification in the given subsystem is modified. “Information space” subsystem (350) translates different type of search specifications.

Search operation can be started explicitly by “System User” or implicitly by changing the search specification. “Search” subsystem (360) reads search specification based on information location, and selects documents as search result, comparing the search specification with information locations of the documents in the information store. As variation, “Search” subsystem (360) could be using different type of search specification, having translated search specification based on information location to this search specification type.

“Results” subsystem (310) presents documents selected by the search subsystem (360) to the “System User” (300). “System User” (300) can access any of presented documents. “System User” (300) can give feedback to the “Result” (310) subsystem, about the documents that were selected by the “Search” subsystem (360). Using feedback, “Result” subsystem (310) can modify the information stored in “Preferences” subsystem (340) or “Search” subsystem (360).

“Preferences” subsystem (340) is used by all subsystems of the invented system. Data stored in the “Preferences” subsystem (340) can be directly modified by a “System User” (300) or modified by subsystems: “Result” (310), “Information space” (350) and “Search Specification based on information location” subsystems (330). Subsystems modify Preferences (340) as result of their interaction with “System User” (330).

The FIG. 4 is a representative schematic diagram illustrating the detailed structure of the invented system and the following subsystems are shown:
“Result” subsystem (450) is composed of modules: “Result display” (451), “Correction (453)”. “Result” subsystem (450) manages data object “Result” (452).
“Search” subsystem (460) is composed of modules: “Search” (461), “Meta information database” (463), “Meta information update” (462). “Search” subsystem (460) creates data object “Result” (452), which is used in “Result” (450) subsystem.
“Information space” subsystem (420) is composed of modules: “Information dimensions manager” (423), “Textual description to information location converter” (424), “Concept relation database” (421), “Information dimensions database” (422).
“Preferences” subsystem (410) is composed of modules: “Preferences editor” (411), “Preferences database” (412).
“Search specification” subsystem (430) is composed of modules: “Editor of Search specification based on a textual description” (431) and “Editor of Search specification based on information location” (432).

The system user (400) is communicating with invented system using User Interface of the system (430). The “Search” subsystem (460) has the meta-information database (463) that contains information about the documents that subsystem allows to search for. Meta-information contains the information that can be used to compute the information location of the document. For performance reason, meta-information can directly contain information location of the documents.

“Information space” subsystem (420) contains the information dimension database that contains the information about the information dimensions that could be used by system user to specify the information location. There are two use cases of invented system presented. In the first use case, the search specification based on information location is used as principal search specification. In the second use case, search specification based on information location is used to correct the user intention expressed first by different type of search specification.

In the first use case, invented system uses information dimensions manager (423), to present to the system user available information dimensions. Available information dimensions are pre configured in the information dimension database (422). New information dimensions can be defined by the system user using concept relation database (421). System user is using “Editor of Search specification based on a textual description” (431) to see existing pre defined information dimensions and to define new ones. System user (400) selects information dimensions and marks the information location on every information dimension. When system user triggers search operation, the system uses the data in the meta-information database (463) to find all documents that are matching the desired information location.

In the second use case, invented system allows entering search specification such as search specification based on a textual description, which will be transformed by “Information space” subsystem (420) to search specification based on information location (425). Transformation is performed using description to information location converter (424). User can modify both search specification based on information location and/or the other search specification, system can use them both.

Once the search specification based on information location is specified, the system will search for the information, and finally, it will present to the system user search result, representing plurality of documents that most closely match the information location specified by the user. Seeing the result, user can request reading of one or more entire documents listed in result. System user can give his feedback about the result presented to him by the system.

The first use case of the invented system has flow of events as following:

Phase 1: Preparation of system parameters.
1. All subsystems and modules set their parameters according to values predefined for all systems users.
2. Context of system usage is detected, by determining system user, location from which the invented system is used etc. Context is used to determine the preferences to be used. Every context has its own set parameters stored in preferences database.
3. All subsystems and modules override their parameters according to values stored for the current context, parameter's values are restored from preferences database.

Phase 2: Acquisition of auxiliary search specification.
4. The system user (400) enters the search specification in the natural text based format using “Editor of search specification based on a textual description” (431).
5. Search specification is analyzed by the “Textual description to information location converter” (424). It is converted to search specification based on information location.
6. The resulting search specification based on information location is displayed to the user in “Editor of search specification based on information location” (432). System user (400) seeing this information can determine if his original intention was correctly interpreted by the system.

Phase 3: Acquisition of the search specification based on the information location.
7. Using “Editor of search specification based on information location” (432), system user can modify the proposed search specification based on information location or enter it entirely. Modification or reentry of search specification is done by system user (400) to correctly express real intentions of search.

Phase 4: Retrieval of documents matching search specification based on the information location.
8. System user (400) triggers search operation. It can be configured, that search would be triggered automatically when user changes any parameter of the search, resulting in refresh of Results Display (451).
9. Search module (460) reads the search specification based on information location (425). It compares the specification with the content of the meta-information database (463) and searches for the documents that are closest to the specification. System uses configuration of the maximum permitted difference between the search specification based on information location (425) and the actual meta-information placement. If the distance of central points of the information location is smaller than the one agreed to be acceptable, the document is added to the results. Better variant of comparison is calculating intersecting area of both information locations, considering full match as 100% of area being and intersection and no match at all as 0% of area being and intersection. Both types of comparisons are done according to known methods in vector space in algebra.

Phase 5: presenting the result.
10. All the information in the meta-information database (463) matching the search specification (430) are displayed to the user. The link to the document, document description and information location of the each of the document are displayed. User can use any of the displayed results to:
   Get more information about it (such as physical location of document, document content, etc).
   Navigate to the original information to read it.

Phase 6: correction of information results. This optional phase allows system user to give feedback about the retrieved documents.
11. System user (400) can notice that information location of the documents in the result is incorrect. Using Result display (451), he can correct information location of the document additionally marking what underlying information will be modified:
   Information location of a single document in the information space. If selected, the “Correction” module will store the document's information location in the preferences database.
   Relations between concepts building the information space. If selected, the “Correction” module will use the Information dimensions manager to modify the Concept relation database. The following algorithm is used:
      For each information dimension of the information location that was modified, the corresponding relation between concepts in the concept relation database is identified. The relation will be modified in such a way, that document's information location would appear to be the same as the corrected information location.
12. Correction module (453) examines the correction, to check if it may apply to a wider group of system users. Examination may be determined using known methods, such as statistical processing of correction done by different users, investigation of locations of modifying users, etc. If the correction is accepted to be applied for wider group of method users, corrections are applied directly in the meta-information database (463) or concept relation database (421), according to the selection made in previous step.

Phase 7: awaiting system user commands.
13. System is waiting for user input. Triggering input can move control to Phase 2 or Phase 3, depending on user input.
   The second use case of the invented system has flow of events as following:

1. Steps defined in Phase 1 of the flow of events of the first use case are executed

2. Control continues starting with Phase 3 of the flow of events in the first use case.

### Module Descriptions

The following are possible modules used in the system. It must be noted, that different set of blocks could be used to achieve the same functional effect, which is the fulfilling of the invented method.

### User Interface

FIG. 5 is a representation of one of the possible graphical user interfaces implementations of the invented system. Description of the figure:

System user controlling the User Interface is using input devices. In typical computers it is a mouse and keyboard, which could be changed for other type of input devices. Graphical Display is what user sees on the display device, and which is composed of two logical parts. One display area will display and allow controlling of the search specifications and the other display area will display and allow controlling of the search results.

Search specification could contain one, two or more ways of entering search specification. In this example of User Interface implementation, two search specifications are used; search specification based on a textual description (511) and search specification based on information location (521).

If option “Synchronize search specification editor automatically” (503) is set, then in event of modification of content of any editors of search specification, all the other search specification editors are updated to match the modified search specification. “Convert to information location” button (512) will start conversion of the “search specification based on a textual description” (511) to the “search specification based on information location” (521). If more search specification editors would be used, this button will start conversion to all the other types of search specifications too.

“Convert to textual description” button (522) will start conversion of the “search specification based on information location” (521) to the “search specification based on a textual description” (511). If more search specification editors would be used, this button will start conversion to all the other types of search specifications too.

“Create new information dimension” button (523) allows creation of new information dimension and adding it to the current search specification based on information location (522).

“Set used information dimensions as preferred” button (524) stores all information dimensions used in the current search specification based on information location (521) in the preferences database, so that next time system user uses the system, stored information dimensions will be automatically displayed in the Editor of the search specification based on information location (520).

“Search” button (504) is used to initiate the searching process. If option “Search automatically when search specifications are modified” (505) is set, the Result display (540) is updated automatically when any of search specification is modified.

“Edit preferences” button (501) allows displaying and modifying of all preferences of the system, applied for the current System user (400) and stored in the preferences database (411).

The search result displays to the user information about the documents matching his search specification most closely. Information location (549-556) of the document is displayed using two sets of dimensions:
Information location 1 (549-552)—using information dimensions used by the user to create search specification based on information location,
Information location 2 (553-556)—using information dimensions used by system or external system to specify documents information location.

In this example User Interface, Search Result is displayed as a list where four entries of this list are shown. Each of them contains document name (541-544), description of the document (545-548) and precise information location (549-556). User can use this information to decide if the specific entry is what he was looking for.

“Retrieve” button (560-563) will retrieve the corresponding document and present it to the user. Document presentation can be performed in a new window.

### Variations:

Varying type of interaction with search engine could be done. It could be for example voice based interaction.
Varying type of information retrieve could be used. For example in case of music the activation would play it, in case of movie played movie could replace entire display area hiding the search panel represented on this User Interface diagram.
Varying placement of the elements on the User Interface can be used.

### Result Display

Displays the result of the search operation. The result will be composed of list or other way of displaying plurality of documents, that match the search specification. For every document in the result, the following information is displayed:
name of the document,
description of the document,
description of the physical location of the document on the storage systems,
information location of the document, using two sets of dimensions:
   Information dimensions used by the user to create search specification based on information location,
   Information dimensions used by system or external system to specify documents information location.

Both information locations are displayed and controlled in the same way as in the editor of the search specification based on information location. Information location can be modified.

### Editor of Search Specification Based on a Textual Description (510)

Module that allows entering and editing of search specification based on a textual description. This could be text entered by keyboard, spoken and recognized sentence or any other way of entering text based information. The module accepts entered textual description and displays it to the user. The information text could be formatted as it is today for the existing search engines such as Yahoo, Google etc.

### Editor of the Search Specification Based on Information Location (520)

Module that allows entering and editing of search specification based on information location. The module can display search specification based on information location in various ways, as presented in “REPRESENTING INFORMATION LOCATION”.

While correcting information location, system user can:

add to the information location any predefined information dimensions,

create new information dimensions and add to the information location,

mark information location on information dimensions,

add information dimensions used in the information location to the preferences database.

### Preferences Editor (412)

At any time of communication with system, allows system user to see and modify preferences stored in the preferences database.

### Search (460)

This module is responsible for searching of documents, using a search specification based on information location (425). It uses the information dimensions manager (423), indirectly accessing information dimension database (422) and the meta-information database (463). Search process could be implemented as following:
1. The search specification based on information location (425) that contains set of information dimensions with information location set on every of them, is read.
2. For every document described in meta-information database, the following operations are performed:
   a. Information dimensions that are used in search specification based on information location (425) are transformed into information dimensions that are used in specification of the information location of the document. This transformation can be done by comparing the relations between concepts that build the information dimensions of information location of document and search specification (430). For every information dimension translated, information location will be modified to reflect its relation to the concept used in destination information dimension.
   b. Information location of the desired information transformed in the previous step and information location of the document are compared to each other. If the distance is smaller than the one agreed to be acceptable, the document is added to the results. The distance could be calculated in several ways, some of the proposed are: average, sum or other operation on the individual differences.
3. Only most relevant documents are used, all other ones are discarded (or to improve performance, kept cached in case user widens the search scope and they will be needed to be displayed). Pre-configured system, user or actual search preferences are used to decide which data to keep.
   Variations: the search and match checking algorithm can be similar to known information searching algorithms and implementations. The difference is that typical systems use keyword based matching, while in this case the matching is done using information location.

### Meta-Information Database (463)

Every document accessible by system has related meta-information that is document's corresponding description in the meta-information database (463). Meta-information contains the following information for every document:
Physical placement of the document—used to locate the document once user is interested to see it and to access the document when updating meta-information.
Information location of the document—used to determine the match between the search specification and the document, which this meta-information represents. See Note 1.

Optional: abstract of the document, shown to the user if the meta-information (which represents original information) matches the search specification.

### Variations:

Instead of information location, meta-information database (463) can contain other type of document specification that would be transformed by additional module to the information location. This variation could be used as a way to improve existing searching engine which would already have existing meta-information database (463) containing keywords related to document. The transformation is necessary, so that the users search request expressed in search specification based on information location could be compared with the placement of the information described by the meta-information database (463).
Keeping both keywords and information dimension information. This scenario could be useful to enable the user to use the standard keyword based searching or the information location based searching.

### Meta-Information Update (462)

This module is used to update information that is kept in the meta-information database (463). It should be included in the system if documents accessed by the system could be modified by external systems. This is a case of the search engine used for searching information on the Internet.

It can be based on the module used in known search systems. Update process would periodically or constantly browse through accessible documents. For every new document or document with changed content:
Changed or new document is read,
In case documents do not have their information location specified, document's information location is calculated, using Textual description to information location converter (424) or process similar to the one performed by the description to information location converter.
Document meta-information is stored in the meta-information database (463), including new calculated information location.

### Information Dimension Database

This module is providing the system with information about the predefined information dimensions. Internally, it stores information in any way such as file, database or other method of storing information.

Every information dimension will be represented by:
Name of the information dimension, which could be composed from names of the concepts building dimensions.
List of orthogonal relations with other information dimensions. Every relation would have orthogonality strength defined. System could be built in such a way, that skipping explicit definition of orthogonality between two information dimensions means they are orthogonal.
Optionally—list of keywords (and their placements on this dimension) that correspond to information locations on this dimension. For example for dimension “Temperature” (expressed by Hot-Cold concepts) related keywords could be: warm, lukewarm, freezing, etc. Every of them would have its location on this dimension.

Information dimension database content is usually predefined by the search engine producer. Optionally, some of the information in Information dimension database (422) could be overridden when processed by the dimensions manager module, to include the user defined dimensions/relations which would be stored in preferences database (411).

Variations: list of orthogonal relations with other information dimensions can be skipped, if the orthogonality information can be defined within concept relation database (421), where it would be defined between concepts, that later build the information dimensions.

### Concept Relation Database (421)

Contains the concepts understood by the system. Internally, it stores information in any way such as file, database or other method of storing information. This module is used by the information dimensions manager (423) to help in finding the information dimensions related to the given concept, in finding information location of the concept on the given information dimensions and in creating new information dimensions.

Internally, the module stores information in any appropriate way such as database, file, set of files, etc. It stores concepts, where every concept contains: name expressed by one or more words, list of relations with other words including type of relation (orthogonality or similarity) and strength of the relation, and optionally a concept can contain other representation of concept such as image, sound, etc. Content of concept relation database will be usually predefined by the search engine producer.

### Variations:

Optionally, some of the information in this database could be overridden when processed by the information dimensions manager module (423), to include the user defined relations which would be stored in preferences database (411).
Concept relation database (421) could be extended or replaced by other known system that describes relations between concepts. One of the candidates might be systems using the Web Ontology Language and the Resource Description Framework, which were defined by W3C. Appropriate modifications in the system main flow must be made, in order to use modified concept relation database.

### Textual Description to Information Location Converter (424)

This module uses information dimensions manager (423) to find the information dimensions which are most related to the search specification (430) entered by the user.

In case of search specification based on a textual description (431), the following operations are performed by the module:
Interprets the description in one of the already known ways (similar to the way that Internet search portals work) to discover the concepts behind the description. Set of “basic concepts” are created.
Uses the Information dimensions manager (423) to decide which information dimensions are related to the “basic concepts”. Information dimensions manager (423) uses Information dimensions database (422) to iterate via information dimensions, then using the Concept relations database (421) it finds the most related information dimensions, by checking the strength of the relation between the “basic concepts” and the concepts creating information dimensions.
Number of information dimensions used in information location is reduced, by selecting those that are the most orthogonal with the rest of information dimensions.
Uses the Information dimensions manager (423) to determine information location of “basic concepts” on the dimensions found in previous steps.

Other types of search specifications (430) require modification of the above conversion operation. For performance reason, some of the operations described above could be combined together or their sequence changed.

### Automatic Determination of Information Dimensions

Using the search specification, system can determine which information dimensions should be presented to the user and what is the information location. In the proposed information location based search engine, this process is done by textual description to information location converter (424). Information dimensions used in information location should be ideally relevant to the keywords and concepts in the search expression and orthogonal to each other as much as possible.

### Preferences Database (411)

Internally, it stores information in any way such as file, database or other method of storing information. This optional module enables personalization of the functions of the system for:
Predefined preferences for all system users of the search engine,
Preference active for the given system user (400), overriding predefined preferences for all system users,
Preference active for the current search operation, overriding preferences for the system user and all system users,
   Data stored in the preferences database include:
Changes made by user in the concept relation database (421) and information dimension database (422), (dimensions created by the user and the orthogonality relation between them). This information is used by the system when searching information.
   Preferences related to the user interface.

If system is implemented as client-server architecture, the system user preferences can be saved in the client or server side of the system. In case the information is saved in the client side, it has to be send to the server every time the system user searches information or starts communication with the system.

### Information Dimensions Manager (423)

This module has following functions:
Construction of new information dimensions using the concepts found in the concept relation database (421), optionally taking into account user preferences (modification of the selected relations).
Looking up of the information dimensions related to the provided concepts (usually expressed as words).
   One of the methods to create set of information dimensions that can be used to construct information location of the given concept is:
1. Concepts with the strongest relation of opposition will be selected.
2. Concepts will be paired to create the candidate information dimensions.
3. Candidate information dimensions are sorted, according to the strength of relation of orthogonality. Only ones with strong orthogonality are used.
   For performance, the above steps could be combined into one, or the data could be preprocessed in some way.

### Information

Represents all the documents that the system has access to. Search engine either directly manages information in the information source or just has access to it, reading the required pieces.

Information source can be:
File, for example managed by e-mail application, application enables searching for information in this file using the search engine.
Set of files, for example MP3 player could use the search engine to enable searching for the specific media file.
Database or set of databases, for example ERP system could employ database systems and enable searching for information.
Internet or intranet, for example search portal using the search engine could enable searching of any information on the Internet/intranet such as pages, images etc.

Meta information update module accesses the information and reflects it into the meta-information database.

### System User (400)

The user of the information retrieval system (usually a human) can be any entity able to communicate with the system. Examples can be: human, information system, software, etc. There can be several system users that can have access to the search engine, search engine can identify them and use unique preferences for each system users when performing search operation.

### Information Objects Description

Data created by system's modules that will be consumed by system's modules or system user.

### Text Based Specification

Please refer to “SEARCH SPECIFICATION BASED ON A TEXTUAL DESCRIPTION”_for information about this type of data. Entered by the user in the User Interface using editor of search specification based on textual description (431), it will be forwarded to the textual description to location converter (424) and could update the search specification of the editors of search specification based on textual description or information location (431, 432) (depending, if this automatic update is enabled in preferences).

### Search Specification Based on Information Location (432)

Please refer to “search specification based on information location” for information about this type of data. This data can be entered by the user to start search, or generated by the system by the Textual description to information location converter (424), or generated by the system by the Textual description to information location converter (424) and then modified by the user.

### Result (452)

It's generated by the search module (461) and displayed to the system user and composed of information about all documents matching the search specification.

### Variations:

System could be controlled by other system. User Interface could be replaced by other type of interface to the external system. In this case, System user (400) would be another system, instead of the human operating system.
In phase 4 of the typical flow of events, preferences database (411) can be used to take into account specific user settings such as changes in the dimension construction (relations between concepts building the dimensions).
In phase 4 of the typical flow of events, maximum permitted difference between the information location of search specification based on information location and of a document could be specified per system that would be overridden with the setting per user that would be overridden with setting per search.
Modules of search subsystem could be reused from known search engine, and all working using search specification based on a textual description. System user (400) could still enter information using information location search specification. This variation would be useful to add new functionality of entering search specification using information location with minimized effort to known search engines. To make it possible, in step 7 of the typical flow of events the search specification based on information location should be first transformed to search specification based on a textual description that could be used in exactly the same way as in known search engine. Example of transformation could be:
   a) Every information dimension of information location search specification is decomposed on concepts it is build of. Result would be two concepts.
   b) Concept related to the location of information on the given dimension is retrieved from Concept relation database (421). For every pair of concepts from information dimension, concepts are found that have a relation with both concepts forming dimensions.
   c) Then, concepts having strength of relation with information dimension concepts proportional to its location on the dimension are selected.
   d) Steps a, b, c are repeated for all information dimensions forming the information location search specification.
   e) Optionally, resulting keywords are filtered out, to reject ones that do not match the group of concepts resulting from conversions of other dimensions. Known algorithms could be used here, such as ones removing SPAM messages.

This variation of the system and its main flow allows rapid construction of invented system, by reusing some of the components of the known systems. The disadvantages might be: loss of accuracy of searching and possible loose of performance.
Meta information database (463) and Meta information update (462) modules might be reused from existing system and working using search specification based on a textual description. Search module would work using search specification based on information location as in the invented system, with the following modification phase 4 of main flow. Instead of directly comparing information location of search specification with information contained in Meta-information database (463), information in the Meta information database must first be converted from textual description of information to information location. To do this:
   a) Search module (461) reads textual description from Meta Information database (463).
   b) Search module passes textual description to Textual description to location converter (424).
   c) Textual description to location converter (424) converts the textual description, which will be usually set of keywords, to the information location. Conversion is done in similar way as step 2 from main flow.
   d) Information location is used in search module when comparing with the search specification based on information location.
More than two different types of search specification could be used; they can be entered using more editors of search specifications. All editors could be synchronized using information space subsystem. Synchronization would happen upon changing search specification in any of editor.
Result (452) is a list of documents, but can be other way of presenting plurality of documents, such as tree, table, etc.
Result (452) contains descriptions of documents, but can be other way of representing documents such as icons, etc.
Each of the modules or subsystems can be implemented as computing system, communicating with other modules. Example of implementations: software module coded in some programming language, computer system composed of hardware and software combination, electronic circuit, electronic expansion board of computer system, computer system composed of computer running.

### Personalization of Search

This extends the basic function of the search engine. The favorite set of information dimensions can be saved for every user. When the user uses dimensions to start searching, dimensions from this favorite set will be displayed before other possible dimensions. When user uses keywords to start searching, dimensions which are related to the information location will be used, with information dimensions from the favorite list before all the others.

The system will search following user specifications preset in the preferences database (411). The user can modify the way system interprets dimensions when performing translation of text based search specification to the information location based search specification and searching information in the search block (461). User will be able to change the relation type and the strength between concepts, resulting in the different way of constructing dimensions.

The user can create new dimensions with a group of dimensions and set (for himself) the orthogonal relation between the new dimension and the rest. For instance, if the system has the following dimensions:

Science—religion, art—mathematics, history—technology, economics—ecology

The user will be able to remove the opposition relation from concepts that could result in example: science—religion→scientology. Now scientology is single point in the information area represented by different dimensions.

New possible dimension: scientology—economics; in this case, the user is “saying” to the system that, for him, “science” and “religion” are synonyms, meanwhile “economics” is antonym of “science” and “religion” at the same time. The user will be able to group two or more concepts (used in pairs to make dimensions) to make new ones.

We claim:

1. A method of information search performed using information location in the information space, the method comprising:
(a) method parameters are set according to predetermined values of method parameters;
(b) initial search specification based on the information location in information space is set to neutral values, an information location in information space is comprised of one or more Information locations within one or more information dimensions that are included in the information space, information space is implementation of vector space, which are known and defined as mathematical concept of algebra;
(c) the search specification based on the information location is modified to reflect the intention of use of this method;
(d) for each document from the plurality of documents that said plurality of documents is the source of documents for this method to search from, information location of the information search specification based on information location is transformed into information location that is constructed using information dimensions that are part of the specification of the information location of the document;
(e) information location of the desired information created in the step (d) and information location of the document are compared to each other, distance between central points of information locations is calculated by known linear algebra rules, if the distance is smaller than the one set as acceptable in method parameters, the document is considered to be matching search specification and added to the results;
(f) information about the documents considered to be matching search specification is presented to the user.

2. The method of claim 1 wherein method parameters are modified by the user.

3. The method of claim 1 wherein method parameters and initial search specification are modified by setting to the predetermined values of method parameters associated with specific method usage context.

4. The method of claim 3 wherein method usage context is determined by user identification or group of users the user is belonging to, wherein discovery of the group the user is belonging to is determined according to at least one method from the group consisting of:
(a) user selects group he is belonging to from the list of groups,
(b) user group is selected according to his geographical location,
(c) user group is selected according to analysis of user previous actions where analysis is done using known methods.

5. The method of claim 1 wherein initial search specification based on the information location is a result of conversion from search specification defined in a different way than search specification based on the information location.

6. The method of claim 5 wherein initial search specification based on the information location is a result of conversion from textual search specification, the method comprising of:
(a) using known methods, a textual description is reduced to the set of one or more “basic concepts”;
(b) for every “basic concept” the information location of the “basic concept” is determined using all the information domains that are taken from a search specification based on information location;
(c) set of information locations of “basic concepts” is processed to form single information location, by combining them using sum of locations or average of the locations.

7. The method of claim 5 wherein user can further correct the information location converted from search specification defined in a different way than search specification based on the information location.

8. The method of claim 1 wherein search specification based on the information location is modified by adding information dimension obtained by means of at least one method from the group consisting of:
(a) selected from predefined information dimension,
(b) newly defined by using two concepts.

9. The method of claim 1 wherein match of the document information and the search specification is decided by percentage of intersecting area of the figures representing information location of the desired information created in the step (d) of the claim 1, and information location of the document by known linear algebra rules; if the intersecting area percentage is higher than the one set as acceptable in method parameters, the document is considered to be matching search specification and added to the results;

10. The method of claim 1 wherein search specification based on information location is transformed into information dimensions that are used in specification of the information location of the documents by the method comprising:
(a) relations between concepts that build the information dimensions of information location of document and search specification are compared;
(b) location of the information of the information location of the search specification is modified to reflect its location relative to the concepts building document.

11. The method of claim 1 optimising searching performance wherein document information is grouped according to common values in information location, allowing comparing of entire groups of document information with search specification based on the information location.

12. The method of claim 1 wherein a match of document and search specification based on the information location is determined by the method converting search specification based on information location to search specification based on a textual description and further comparing converted search specification with textual description of the document, the method comprising:
(a) every information dimension of search specification based on information location is decomposed to concepts it is build of, resulting in two concepts per information dimension, which are called base concept A and base concept B;
(b) for each pair of base concepts, all concepts related to each of the base concepts are retrieved from concept relation database;
(c) concepts are filtered out to keep only those that have its relation with base concept A and base concept B proportional to the information location on the information dimension that is formed from those base concepts;
(d) the keywords representing concepts are used as search specification based on a textual description;
(e) known method of comparing textual information identifying document and search specification based on a textual description is used to determine result of the match.

13. The method of claim 12 wherein the keywords representing concepts are filtered out using known methods for detecting information that do not match the rest of information.

14. The method of claim 1 wherein stored textual descriptions of documents are converted to information location being later matched with search specification, the method comprising:
(a) using known methods, a textual description is reduced to the set of one or more “basic concepts”;
(b) for every “basic concept” the information location of the “basic concept” is determined using all the information domains that are taken from a search specification based on information location;
(c) set of information locations of “basic concepts” is processed to form single information location, by combining them using sum of locations or average of the locations.

15. The method of claim 1 wherein at anytime, modification of search specification, triggers searching process.

16. The method of claim 15 wherein documents found in last search are treated according to at least one of the methods from the group consisting of:
(a) documents are removed from result,
(b) documents are kept and displayed together with documents found using new search.

17. The method of claim 1 wherein for documents considered to be matching search specification, their information is presented comprising: document name, document summary.

18. The method of claim 1 wherein documents considered to be matching search specification are presented to the user all at once or as a part only, user is able to select which portion of all resulting documents is presented at once.

19. The method of claim 18 wherein if enabled by method parameters, each document considered to be matching search specification is displayed with its information location in the information space, where information dimensions that are used in construction of displayed information location are ones from the group consisting of:
(a) information dimensions as included in the description of the document,
(b) information dimensions used in search specification based on the information location.

20. The method of claim 18 wherein each document considered to be matching search specification is displayed according to at least one of the arrangements from the group consisting of:
(a) document list,
(b) document grid,
(c) information locations of the documents presented on the graphically represented information space, where representation is implemented as one of known methods of graphical representation of vector space.

21. The method of claim 20 wherein information location of the documents matching user search specification are displayed as graphical areas located in graphical space representing information space, information space is drawn according to known methods of graphical representation of vector space on at least one of the graphical spaces from the group consisting of:
(a) two dimensional graphics,
(b) pseudo three dimensional graphics,
(c) full three dimensional graphics.

22. The method of claim 20 wherein search specification is displayed using the same technique as used for displaying the information location of the matching documents.

23. The method of claim 1 wherein predetermined values of method parameters are modified by user action according to method comprising:
(a) information location of one of the documents shown in the result are marked to be corrected;
(b) information location of one of the documents are corrected according to the user selection;
(c) the correction is examined, and depending on choice of correction applied to data used by wider group of method users by applying directly to the single information location of the document or predetermined values of method parameters, according to the selection made by user.

24. The method of claim 23 wherein examination is performed using known methods, such as statistical processing of correction taking into account user group.

25. The method of claim 23 wherein Information entered by user modifies predefined method parameters according to at least one method from the group consisting of:
(a) replacement of previous data,
(b) information entered by user is stored and processed together with information coming from other users,
(c) information entered by the user influences the original information by adding user values multiplied with modification factor defined in method parameters.

26. The method of claim 23 wherein correction of the information location of a single document in the information space is performed, comprising of:
(a) for each information dimension of the information location that was modified, the information location of the document on that information dimension is memorized and applied in the future uses of the method in the same context.

27. The method of claim 23 wherein correction of the concept relations building the information space is performed, comprising of:
(a) for each information dimension of the information location that was modified, the corresponding relation between concepts in the concept relation database is identified and modified,
(b) the modification is memorized, and applied in the future uses of the method in the same context.

28. The method of claim 1 wherein information location on information dimension is a specific value on given dimension which is a point in vector space defined in the algebra.

29. The method of claim 1 wherein information location on information dimension are one or more pairs of minimal and maximal values on that dimension identifying selected values, which is line fragment in a vector space in the algebra.

30. The method of claim 1 wherein each dimension is comprised of at least two ending points, where a pair of ending points represent different, preferably antagonistic concepts.

31. The method of claim 1 wherein each dimension is comprised of at least two ending points, one of the point is representing null value of the concept or concepts, and one or more points are representing the concept.

32. The method of claim 1 wherein used information dimensions are predefined and stored in the system.

33. The method of claim 1 wherein used information dimensions are constructed by user.

34. The method of claim 1 wherein information location is represented as manipulable graphical display composed of objects representing information dimensions and information locations marked within information dimensions.

35. The method of claim 34 wherein information location is represented as set of one or more search bars, every bar representing one information dimension, and having information location marked on the bar.

36. The method of claim 34 wherein information location is displayed graphically, one or more dimensions are corresponding to dimensions in the graphical space and information locations correspond to areas in graphical space, information space is drawn according to known methods of graphical representation of vector space on at least one of the graphical spaces from the group consisting of:
(a) two dimensional graphics,
(b) pseudo three dimensional graphics,
(c) full three dimensional graphics.

37. The method of claim 1 wherein information location is represented as alphanumerical data representing values for each information dimension comprising:
(a) information dimension name;
(b) the minimum and maximum ranges of locations on this information dimension;
(c) list of the ranges within the information dimension that describes information location within information dimension.

38. A method of classification of documents by determining document information location comprising:
(a) document textual description is obtained;
(b) using known methods, a textual description is reduced to the set of one or more “basic concepts”;
(c) set of information locations is produced, where each one corresponds to one “basic concept”;
(d) for every “basic concept” the information location of the “basic concept” is determined using all the information dimensions that are predefined in the search system;
(e) set of information locations of “basic concepts” is processed to form single information location.

39. The method of claim 38 wherein document textual description is extended with a result of processing of document content comprising:
(a) document is translated from original document language to one of languages used in declaring concepts forming information dimensions;
(b) translated text is reduced by removing words not playing significant role in the document text;
(c) reduced text is added to the textual information of the document.

40. The method of claim 38 wherein document textual description is extended with a result of processing of documents that are linked to by the document comprising:
(a) documents referenced by the links in original document are fetched,
(b) fetched documents are translated from original document language to one of languages used in storing concepts forming information dimensions;
(c) translated text is reduced by removing words not playing significant role in the document text;
(d) reduced text is added to the textual information of the document.

41. The method of claim 38 wherein “basic concepts” are processed to form single information location by using one of the operations from the group consisting of:
(a) sum values of all locations,
(b) average values of the locations.

42. The method of claim 38 wherein method user modifies document information location in information space.

43. The method of claim 42 wherein Information entered by user modifies document information location in information space according to at least one method from the group consisting of:
(a) replacement of previous data,
(b) information entered by user is stored and processed together with information coming from other users,
(c) information entered by the user influences the original information by adding user values multiplied with modification factor defined in method parameters.

44. The method of claim 38 wherein search specification based on the information location is modified by adding information dimension obtained by means of at least one method from the group consisting of:
(a) selected from predefined information dimension,
(b) newly defined by using two concepts.

45. An apparatus for searching information using information location in the information space, comprising of:
(a) preferences subsystem;
(b) search specification editing subsystem;
(c) result presentation subsystem;
(d) information space processing subsystem;
(e) search subsystem;
(f) information source.
(g) a machine-readable medium having stored thereon machine-executable instructions.

46. An apparatus of claim 45 wherein the preferences system comprises of:
(a) preferences database storing all preferences users of apparatus;
(b) preferences editor allowing displaying and modification of data in preferences database.

47. An apparatus of claim 45 wherein the search specification editing subsystem comprises of:
(a) editor of search specification based on textual description allowing entering of preliminary search specification based on textual description, which upon its completion is being send to textual description to information location converter;
(b) editor of search specification based on information location in information space allowing to enter initial search specification based on information location or allowing correction of search specification based on information location received from textual description to information location converter.

48. An apparatus of claim 45 wherein the result presentation subsystem comprises of:
(a) result display presenting documents matching search specification and received from search module;
(b) result correction editor allowing correcting of individual document information locations which are forming search result, said correction is modifying apparatus preferences basing on performed correction.

49. An apparatus of claim 45 wherein the information space processing subsystem comprises of:
(a) concept relation database used in constructing and operating on information dimensions;
(b) information dimension database used in operations on information locations;
(c) information dimensions manager operating on information locations using concept relation database and information dimension database;
(d) textual description to information location converter using information dimensions manager to convert search specification based on text to search specification based on information location.

50. An apparatus of claim 45 wherein the search subsystem comprises of:
(a) search module, comparing information locations of documents and information location of search specification and generating list of documents that are considering to be matching the search specification;
(b) meta information database, containing information about documents in the information source and used to fetch document information when comparing with search specification;
(c) meta information update, updating meta information database basing on data in the information source.

51. An apparatus of claim 45 wherein the machine-readable medium having stored thereon machine-executable instructions when executed by a machine:
(a) sets parameters of all subsystems and modules according to values predefined for all systems users;
(b) sets parameters of all subsystems and modules according to preferences associated with current usage context of apparatus;
(c) sets initial search specification based on the information location in information space to neutral values, where an information location in information space is comprised of one or more Information locations within one or more information dimensions that are included in the information space, information space is implementation of vector space, which are known and defined as mathematical concept of algebra;
(d) captures user search intention as search specification based on the information location;
(e) transforms information location of the information search specification based on information location for each document from the plurality of documents that said plurality of documents is the source of documents for this method to search from, into information location that is constructed using information dimensions that are part of the specification of the information location of the document;
(f) calculates distance between central points of information locations of the desired information created in the step (e) and information location of the document, calculation uses known linear algebra rules, if the distance is smaller than the one set as acceptable in preferences adds the document to the result;
(g) presents to the user information about the documents considered to be matching search specification being result created in step (f).
